(19) United States
(12) Patent Application Publication
(10) Pub. No.: US 2025/0354089 A1
(43) Pub. Date: Nov. 20, 2025

(54) HIGH FOAMING TABLET COMPOSITIONS AND USES THEREOF

(71) Applicant: ECOLAB USA INC., Saint Paul, MN (US)

(72) Inventors: Ryan Giffin Moore, Lilburn, GA (US); Matthew Frederick Slozer, Kernersville, NC (US); Wendy Lo, Woodbury, MN (US); Emily Olson, Minneapolis, MN (US); Erik C. Olson, Eagan, MN (US)

(21) Appl. No.: 19/207,683

(22) Filed: May 14, 2025

Related U.S. Application Data
(60) Provisional application No. 63/649,112, filed on May 17, 2024.

(51) Int. Cl. C11D 1/94; B08B 3/08; C11D 1/06; C11D 1/14; C11D 1/22; C11D 1/36; C11D 1/72; C11D 1/90; C11D 3/00; C11D 3/04; C11D 3/20; C11D 17/00

(52) U.S. Cl. CPC C11D 1/94; B08B 3/08; C11D 3/0094; C11D 3/046; C11D 3/2065; C11D 3/2079; C11D 3/2086; C11D 17/006; C11D 1/06; C11D 1/143; C11D 1/146; C11D 1/22; C11D 1/36; C11D 1/72; C11D 1/90

(57) ABSTRACT

Pressed tablet compositions providing stabilized foaming and fast dissolution times of the tablets are provided. In particular, high foaming tablet compositions with a significantly smaller amount of surfactant active ingredients are provided along with methods of use thereof that are suitable for use as detergent compositions, foaming hand soap compositions, hard surface cleaning compositions, and carpet shampoo compositions for consumer and institutional uses.

### CROSS-REFERENCE TO RELATED APPLICATION

This application claims priority under 35 U.S.C. § 119 to Provisional Application U.S. Ser. No. 63/649,112, filed on May 17, 2024, which is herein incorporated by reference in its entirety including without limitation, the specification, claims, and abstract, as well as any figures, tables, or examples thereof.

### TECHNICAL FIELD

The disclosure relates generally to pressed tablet compositions providing stabilized foaming and fast dissolution times of the tablets. The present disclosure provides pressed compositions and methods of use suitable for use as detergent compositions, foaming hand soap compositions, hard surface cleaning compositions, and carpet shampoo compositions for consumer and institutional uses. More particularly, the present disclosure relates to high foaming tablet compositions with a significantly smaller amount of surfactant active ingredients.

### BACKGROUND

There is an ongoing demand for solid compositions to replace liquid formulations in both consumer and institutional products. An advantage of solid compositions can include sustainability due to the reduction in packaging of a solid composition compared to a liquid counterpart that is often largely made up of water. Such a solid replacing a liquid further reduces shipping costs and burdens, as well as storage requirements of liquids compared to solids in terms of both shelf stability as well as space required to store the products. In many consumer and institutional settings, use of solids to generate a use solution for a particular application is desirable for each of these reasons over use of a liquid counterpart.

Tablets provide individual doses of cleaning compositions. Many consumers find tablet forms of cleaning compositions to be more convenient and in some applications more attractive than traditional liquid or powder forms. Tablets are more compact, and thus facilitate transport and storage. Tablets also eliminate the need for measuring, resulting in precise dosing and avoiding wasteful overdosing or underdosing. Tablets also make the compositions easier to handle and dispense. For these reasons, cleaning products in tablet form have become very popular.

There is an ongoing need to provide solid compositions, including tablets, suitable for a variety of uses both consumer and institutional. However, there is often a challenge in providing solid compositions that are able to quickly dissolve into a use solution. Users do not want the unnecessary delay in time it takes for a solid to dissolve into a use solution, nor the large volumes and/or extremely high water temperatures it can take for a solid composition to dissolve into a use solution.

It is therefore an object of this disclosure to provide solid tablet compositions suitable for a variety of uses both consumer and institutional.

It is a further object of the disclosure to provide solid tablet compositions that are able to quickly dissolve into a use solution, such as within about 10 minutes or less.

It is another object of this disclosure to formulate solid tablet compositions that provide high foaming with a significantly smaller amount of surfactant active ingredients in comparison to commercial competitive liquid product formulations.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide a solid tablet composition comprising an alkali metal carbonate alkalinity source, an acid component, an anionic surfactant, an amphoteric surfactant, and glycerin, wherein the weight-% ratio of the components in the solid tablet composition is from about 2:1:2 (anionic surfactant to amphoteric surfactant to glycerin) to about 3:1:3, or from about 2:1:2 to about 3:1:2. In some embodiments, the composition further comprises magnesium sulfate, wherein the weight-% ratio of the components in the solid tablet composition is from about 2:1:2:0.5 (anionic surfactant to amphoteric surfactant to glycerin to magnesium sulfate) to about 3:1:3:1, or from about 2:1:2:0.5 to about 3:1:2:1.

It is a further object, feature, and/or advantage of the present disclosure to provide a use solution of the tablet composition comprising an aqueous solution of the tablet composition described herein, wherein the aqueous solution has a pH between about 2 and about 11, and stabilized foam with a total active surfactant concentration less than or equal to about 1000 ppm.

It is a further object, feature, and/or advantage of the present disclosure to provide a method of use comprising adding the tablet composition described herein into an aqueous solution to dissolve the tablet composition to form a use solution within about 15 minutes or less and contacting a surface with the use solution.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a graph of foam height percentage versus soil removal for the formulations tested in Example 1.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that pressed tablet compositions provide stabilized foaming and fast dissolution times to provide use solutions of the compositions.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1%, and 4%. This applies regardless of the breadth of the range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, foam height, soil removal, temperature, pH, humidity, ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “analog” means a molecular derivative of a molecule. The term is synonymous with the terms “structural analog” or “chemical analog.”

As used herein, the term “between” is inclusive of any endpoints noted relative to a described range.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the phrase “consumer” refers to a non-institutional use as well as the purchaser who intends to use a product or a commodity for a non-industrial and business use, such as a use of a product within a consumer's own home.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

The term “hard surface” refers to a solid, substantially non-flexible surface such as a counter top, tile, floor, wall, panel, window, plumbing fixture (e.g. drain), kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.), or fabric surfaces, e.g., knit, woven, and non-woven surfaces (such as surgical garments, draperies, bed linens, bandages, etc.), or patient-care equipment (such as respirators, diagnostic equipment, shunts, body scopes, wheel chairs, beds, etc.), or surgical and diagnostic equipment. Health care surfaces include articles and surfaces employed in animal health care.

As used herein, the term “institutional” is meant that the use or operations are located in a commercial or service industry including but not limited to hotels, motels, hospitals, nursing homes, restaurants, bars, health clubs, schools, colleges, universities, and the like.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x” mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “surfactant” or “surface active agent” refers to an organic chemical that when added to a liquid, changes the properties of that liquid at a surface.

As used herein, “tablet” refers to any unitary solid form preparation where the dosage of each unit is fixed by size and weight. Tablets can be of any shape and can be prepared using any method known in the art, including compression, casting, briquetting, injection molding and extrusion. In preferred embodiments the solid tablet compositions are prepared by tablet pressing. In preferred embodiments the solid tablet compositions are prepared by a rotary tablet press.

As used herein the terms “use solution,” “ready to use,” or variations thereof refer to a composition that is diluted, for example, with water, to form a use composition having the desired components of active ingredients for the intended use. For reasons of economics, a concentrate can be marketed, and an end-user can dilute the concentrate with water or an aqueous diluent to a use solution.

As used herein, the term “ware” refers to items such as eating and cooking utensils, dishes, pots and pans, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Tablet Compositions

According to embodiments, the tablet compositions are pressed solids providing stabilized foaming and fast dissolution times of the tablets. The tablet compositions provide high foaming with a significantly smaller amount of surfactant active ingredients, namely less than about 500 ppm active surfactant concentration in a use solution generated from the tablet composition.

According to embodiments, the tablet compositions include an alkali metal carbonate alkalinity source, an acid component, an anionic surfactant, an amphoteric surfactant, and glycerin. According to additional embodiments, the tablet compositions include an alkali metal carbonate alkalinity source, an acid component, an anionic surfactant, an amphoteric surfactant, glycerin, and magnesium sulfate. The tablet compositions can further include additional functional ingredients.

In embodiments it is desired to have the weight-% ratios of the components for stabilizing foam in the use solution as well as maintaining the rapid dissolution time (e.g. about 10 minutes or less) within the following ranges. In an embodiment the weight-% ratio of the components in the solid tablet composition is from about 2:1:2 (anionic surfactant to amphoteric surfactant to glycerin) to about 3:1:3, or from about 2:1:2 to about 3:1:2. In a further embodiment the weight-% ratio of the components in the solid tablet composition is about 2:1:2 (anionic surfactant to amphoteric surfactant to glycerin).

In further embodiments it is desired to have the weight-% ratios of the components for stabilizing foam in the use solution as well as maintaining the rapid dissolution time (e.g. about 10 minutes or less) within the following ranges. In an embodiment the weight-% ratio of the components in the solid tablet composition is from about 2:1:2:0.5 (anionic surfactant to amphoteric surfactant to glycerin to magnesium sulfate) to about 3:1:3:1, or from about 2:1:2:0.5 to about 3:1:2:1. In a further embodiment the weight-% ratio of the components in the solid tablet composition is about 2:1:2:0.5 (anionic surfactant to amphoteric surfactant to glycerin to magnesium sulfate).

Exemplary tablet compositions are shown in Table 1 in weight percentage. While the components may have a percent active of 100%, it is noted that Table 1 does not recite the percent actives of the components, but rather, recites the total weight percentage of the raw materials (i.e. active concentration plus inert ingredients, such as water).

TABLE 1

| | First | Second | Third |
|---|---|---|---|
| | Exemplary | Exemplary | Exemplary |
| Material | Range wt.-% | Range wt.-% | Range wt.-% |
| Alkali Metal Carbonate | 10-40 | 15-30 | 20-30 |
| Alkalinity Source | | | |
| Acid Component | 20-60 | 30-60 | 40-50 |
| Anionic Surfactant | 0.1-10 | 1-10 | 1-5 |
| Amphoteric Surfactant | 0.05-10 | 0.1-10 | 1-2 |
| Glycerin | 0.1-10 | 1-10 | 1-5 |
| Magnesium Sulfate | 0-10 or 0.1-10 | 0.1-5 | 0.1-2 |
| Optional Additional | 0-25 | 0-20 | 0-15 |
| Functional Ingredients | | | |
| Total | 100 | 100 | 100 |

The tablet compositions are substantially free of water. In embodiments the compositions have less than about 10 wt-% water, preferably less than about 5 wt-% water. In embodiments the tablet compositions have water present, including from use of liquid components, in an amount of from about 0.1% to about 10%, or 0.5% to about 7.5%, or about 1% to about 5% of the total weight of the tablet.

The tablet compositions are pressed solids. The compositions can be made by combining raw materials into a homogenous mixture before pressing the compositions into a desired shape and size. In embodiments the tablets can have any desired diameter, such as a diameter of between about 5 mm and about 75 mm. In some applications, the tablets have a diameter of at least 5 mm, at least 10 mm, at least 15 mm, at least 20 mm, at least 25 mm, at least 30 mm, at least 35 mm, at least 40 mm, at least 45 mm, at least 50 mm, at least 55 mm, at least 60 mm or at least 70 mm. The tablets compositions described herein can be of any weight, such as a weight between 100 mg and 100 g. In preferred embodiments the tablet compositions have a weight between about 5 g to about 30 g.

In some embodiments it is desirable for the tablet compositions to have a size and dissolution between about 0.5-20 grams tablet per Liter water for dissolution. In some embodiments it is desirable for the tablet compositions to have a size and dissolution between about 0.75-15 grams tablet per Liter water for dissolution. In some embodiments it is desirable for the tablet compositions to have a size and dissolution between about 0.75-13 grams tablet per Liter water for dissolution.

Any tableting equipment known in the art can be used for tablet formation. Suitable equipment includes a standard single stroke or a rotary press. Such presses are commercially available, and are available from, e.g., Carver, Inc. (Wabash, Ind.), Compression Components & Service, LLC (Warrington, Pa.), Specialty Measurements Inc. (Lebanon, N.J.), GEA Pharma Systems (Wommelgem, Belgium), Korsch America Inc. (South Easton, Mass.), Elizabeth Companies (North Huntingdon, PA) or Bosch Packaging Technology (Minneapolis, Minn.).

The tablet compositions can be made at room temperature (21° C. or 70° F.) under atmospheric pressure, and is not adversely affected by temperature or pressure conditions. However, high humidity can have a negative impact on tableting. The tablet can be compressed by applying a compression pressure of at least about 1500 PSI, preferably at least 1750 PSI. In some applications, the tablet is compressed applying a compression pressure of at least 2000 PSI, or at least 2500 PSI, or at least 5000 PSI, or at least 7500 PSI, or greater.

The compositions beneficially do not require a heated or cooled curing step to solidify into a stable solid composition. The amount of time the compositions are cured depends on a variety of factors, including, but not limited to, the desired rigidity of the solid composition, the ingredients present in the solid, and the desired end use of the solid. In some embodiments, the compositions are cured for at least about 30 minutes, at least about 1 hour, at least about 1 day, or at least about 1 week. In other embodiments, the compositions are cured for about 15 to about 30 minutes. The compositions are cured at ambient temperature. That is, the compositions do not require heating or cooling during the cure step.

The tablet compositions have a tablet hardness that exhibits or provides an optimal operating range for both tablet hardness and the desired product aesthetics and dissolution characteristics described herein. In embodiments, the tablet composition can have a tablet hardness between about 10-40 lb-f. As an example, such hardness can be measured by placing a tablet in an IMADA 44 force gauge (IMADA, Inc. Northbrook IL) wherein the diameter is in the vertical position. The meter is manually operated by applying force to the tablet until the tablet breaks. The peak force measurement is then recorded as the break strength of the tablet tested.

The tablet compositions are beneficially safe to handle tablets and do not require personal protective equipment (PPE). PPE may include, for example, goggles, eye wash stations, masks and other protective equipment. In such embodiments a use solution of the solid compositions can preferably have a pH from about 4 to about 9, or from about 6 to about 8.

The compositions can be packaged in various types of containers with a shelf-stability of up to 2 years. The compositions can be wrapped in a barrier film to increase storage stability. Barriers can include oil wrapping, film, PVA or without a primary wrapping. Additional suitable barrier films can include nylons, polyethylene terephthalate, fluorinated polyethylenes, and copolymers of acrylonitrile and methyl methacrylate. Further the compositions can include a container suitable for containing the tablets, such as for shipping and/or storage. The tablets containing the tablet binding composition provided herein can be stored or shipped in a variety of containers, and the containers can be made of or contain any of a variety of container materials, such as glass, acrylonitrile butadiene styrene (ABS), high impact polystyrene, polycarbonate, high density polyethylene, low density polyethylene, high density polypropylene, low density polypropylene, polyethylene terephthalate, polyethylene terephthalate glycol and polyvinylchloride and combinations thereof. In embodiments the tablet compositions are placed within a container material, such as for example, a corrugated box, a chipboard carton, a flexible plastic pouch, a paper bag, a plastic or glass container, such as a rigid plastic container or a glass container.

### Alkalinity Source

The tablet compositions comprise an alkali metal carbonate alkalinity source. The alkalinity source must be compatible with the other components of the solid tablet composition. In an embodiment the alkalinity source and the acid component beneficially aid in the rapid dissolution of the tablet composition while maintaining the desired use pH range. Carbonates can include carbonates and/or bicarbonates. Exemplary sources of alkalinity include alkali metal carbonates and alkali metal bicarbonates, including sodium carbonate, potassium carbonate, sodium bicarbonate, potassium bicarbonate, magnesium carbonate, sodium glycine carbonate, or mixtures thereof, and most preferred is sodium carbonate.

In some embodiments, the alkalinity source is included in the tablet compositions at an amount of at least about 10 wt-% to about 40 wt-%, about 15 wt-% to about 40 wt-%, about 15 wt-% to about 30 wt-%, or about 20 wt-% to about 30 wt-%. In addition, without being limited according to the disclosure, all ranges recited are inclusive of the numbers defining the range and include each integer within the defined range.

### Acid Component

The tablet compositions comprise an acid component. The acid component must be compatible with the other components of the solid tablet composition. In an embodiment the alkalinity source and the acid component beneficially aid in the rapid dissolution of the tablet composition while maintaining the desired use pH range. Without being bound by a particular mechanism of action, the acid component reacts with the alkalinity source to create effervescence to enhance the rate or speed of the physical break-up of the solid composition. Exemplary acid components include an acid or salt thereof. Preferably the acid has an aqueous solubility between 0.1 g/L and 1500 g/L at 20° C., more preferably between 0.25 g/L and 500 g/L at 20° C., most preferably between 0.25 and 100 g/L at 20° C. As used herein, the g/L description refers to the mass of acid added with sufficient aqueous medium (e.g., water) to form one liter of solution.

An exemplary acid component includes polycarboxylic acids. More preferably, the acid component is a polycarboxylic acid having between 2 and 4 carboxyl groups. More preferably the polycarboxylic acid is a dicarboxylic acid or a tricarboxylic acid.

Exemplary acid components can citric, adipic, fumaric, malic, maleic, succinic, glycolic, ascorbic, oxalic, monosodium citrate, sulfamic and sodium bisulfate, salts of the foregoing, and mixtures thereof. In an embodiment the acid component is citric acid.

In some embodiments, the acid component is included at weight-% ratio with the alkali metal carbonate alkalinity source from about 1:1 to about 3:1, or preferably from about 1.5:1 to about 3:1, or more preferably about 2:1. In addition, without being limited according to the disclosure, all ranges recited are inclusive of the numbers defining the range and include each integer within the defined range.

In some embodiments, the acid component is included in the tablet compositions at an amount of at least about 20 wt-% to about 60 wt-%, about 30 wt-% to about 60 wt-%, about 40 wt-% to about 60 wt-%, or about 40 wt-% to about 50 wt-%. In addition, without being limited according to the disclosure, all ranges recited are inclusive of the numbers defining the range and include each integer within the defined range.

### Anionic Surfactants

The tablet compositions comprise one or more anionic surfactants. Anionic surfactants can include carboxylate, sulfonate, sulfate and phosphate as the polar (hydrophilic) solubilizing groups. Of the cations (counter ions) associated with these polar groups, sodium, lithium and potassium impart water solubility; ammonium and substituted ammonium ions provide both water and oil solubility; and calcium, barium, and magnesium promote oil solubility. Anionics are excellent detersive surfactants.

Anionic sulfate surfactants can include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). Anionic sulfonate surfactants suitable for use also include alkyl sulfonates, the linear and branched primary and secondary alkyl sulfonates, and the aromatic sulfonates with or without substituents.

Anionic carboxylate surfactants suitable for use include carboxylic acids (and salts), such as alkanoic acids (and alkanoates), ester carboxylic acids (e.g., alkyl succinates, such as sodium dioctyl sulfosuccinate), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g., alkyl carboxyls). Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula: R—O—(CH₂CH₂O)ₙ(CH₂)ₘ—CO₂X (3) in which R is a C₈ to C₂₂ alkyl group or

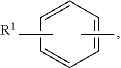

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

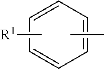

and R¹ is a C₆-C₁₂ alkyl group. In still yet other embodiments, R¹ is a C₉ alkyl group, n is 10 and m is 1.

Exemplary anionic surfactants include linear alkylbenzene sulfonate, sodium dodecylbenzene sulfonate, sodium lauryl sulfate, sodium coco-sulfate, sodium alpha-olefin sulfonate, sodium laureth sulfate, sodium lauroyl sulfoacetate, sodium methyl cocoyl taurate, sodium lauryl sarcosinate, sodium cocoyl isethionte, lauryl glucosides, coco glucosides and combinations thereof. In preferred embodiments, the anionic surfactant comprises linear alkylbenzene sulfonate, sodium lauryl sulfate, and combinations thereof.

In some embodiments, the anionic surfactant(s) is included in the tablet compositions at an amount of at least about 0.1 wt-% to about 20 wt-%, about 0.1 wt-% to about 10 wt-%, about 1 wt-% to about 10 wt-%, or about 1 wt-% to about 5 wt-%. In addition, without being limited according to the disclosure, all ranges recited are inclusive of the numbers defining the range and include each integer within the defined range.

### Amphoteric Surfactants

The tablet compositions comprise one or more amphoteric surfactants. Exemplary amphoteric surfactants include betaines, sultaine and amine oxide surfactants. Betaine and sultaine surfactants have the general formula for these compounds is:

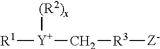

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Further examples of these structures include a betaine of the general structure:

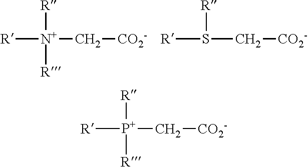

as they do not exhibit strong cationic or anionic characters at pH extremes, nor do they show reduced water solubility in their isoelectric range.

Examples of suitable amine oxides include but are not limited to those having a general structure:

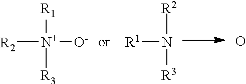

wherein R₁, R₂, and R₃ are independently selected from saturated or unsaturated and straight or branched alkyl groups having from 1-24 carbons and aromatic groups, etc. and which can optionally contain O, N or P as a heteroatom or polyalkoxy groups.

In an embodiment, R₁ is an alkyl group having 4-18 carbons and R₂ and R₃ are alkyl groups having 1-18 carbons. In an embodiment, R₁ is an alkyl group having 6-10 carbons and R₂ and R₃ are alkyl groups having 1-2 carbons.

In an embodiment, R₁ is an alkyl group having 8 carbon atoms and R₂ and R₃ are alkyl groups having 1-2 carbon atoms. In an embodiment, R₁ is an alkyl group having 12 carbons and R₂ and R₃ are alkyl groups having 1-2 carbons.

Additionally, or alternatively, the compositions may include one or more alkyl ether amine oxides according to the general structure

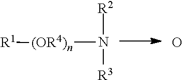

wherein R¹ is an alkyl group from having 8-16 carbons or a blend thereof, or greater than 8 and fewer than 16 carbons, or a blend thereof; wherein R² and R³ are alkyl or hydroxyalkyl group of C₁-C₃ or a mixture thereof; R⁴ is an alkylene group, a hydroxyalkylene group, or an alkyl ether group. In an embodiment, R⁴ preferably has 1 to 6 carbon atoms, more preferably 2 to 4 carbon atoms, and still more preferably 2 to 3 carbon atoms; and wherein n ranges from 0 to about 20.

Examples of amine oxides include, but are not limited to alkyl dimethyl amine oxide, dialkyl methyl amine oxide, alkyl dialkoxyamine oxide, dialkyl alkoxyamine oxide, dialkyl etheramine oxide and dialkoxyetheramine oxide, octyldimethylamine oxide, myristyldimethylamine oxide, didecylmethylamine oxide, methylmorpholine oxide, tetradecyldiethoxyamine oxide, and lauryldimethylamine oxide. Particularly suitable amine oxides include octyldimethylamine oxide, dodecyldimethyl amine oxide, lauryldimethylamine oxide, cocoamine oxide, a C₁₀-C₁₆ amine oxide or a blend thereof. Particularly preferred amine oxides include a blend of lauric, myristic, palmitic, octyl, decyl, and oleyl amine oxides, or a blend thereof. Such a blend of amine oxides may be obtained commercially as Barlox 12.

Exemplary betaines, sultaine and amine oxide surfactants include, for example, cocamidopropyl betaine, cocamidopropyl hydroxysultaine, lauramidopropyl betaine, amidopropyl betaine, amidopropyl hydroxysultaine, sodium cocamphoacetate, sodium cocamphopropionate, cocamidopropylamine oxide, alkyl amine oxides, lauryldimethylamine oxide, and combinations thereof. In some embodiments, the amphoteric surfactant(s) is included in the tablet composition at an amount of at least about 0.05 wt-% to about 15 wt-%, about 0.1 wt-% to about 10 wt-%, about 1 wt-% to about 5 wt-%, or about 1 wt-% to about 2 wt-%. In addition, without being limited according to the disclosure, all ranges recited are inclusive of the numbers defining the range and include each integer within the defined range.

### Glycerin

The tablet compositions comprise glycerin to pre-solubilize the surfactant materials in the tablet composition to increase the rate of dissolution of the solid tablet compositions while also beneficially stabilizing foaming in the use composition. Glycerin can be included at various concentrations. In an embodiment a glycerin with very liquid water is included, such as glycerin 99.5%.

In some embodiments, the glycerin is included in the tablet composition at an amount of at least about 0.1 wt-% to about 20 wt-%, about 0.1 wt-% to about 10 wt-%, about 1 wt-% to about 10 wt-%, or about 1 wt-% to about 5 wt-%. In addition, without being limited according to the disclosure, all ranges recited are inclusive of the numbers defining the range and include each integer within the defined range.

### Magnesium Sulfate

The tablet compositions can further comprise magnesium sulfate. Various forms of the salt can be included, for example, anhydrous, monohydrate, tetrahydrate, pentahydrate, hexahydrate, heptahydrate, or combinations thereof.

In some embodiments, the magnesium sulfate is included in the tablet composition at an amount of at least about 0 wt-% to about 20 wt-%, about 1 wt-% to about 20 wt-%, about 5 wt-% to about 20 wt-%, about 10 wt-% to about 15 wt-%, or about 10 wt-% to about 12 wt-%. In addition, without being limited according to the disclosure, all ranges recited are inclusive of the numbers defining the range and include each integer within the defined range.

### Additional Functional Ingredients

The components of the solid tablet compositions can further be combined with various functional components suitable for uses disclosed herein. In some embodiments, the solid tablet compositions including the alkali metal carbonate alkalinity source, acid component, anionic surfactant, amphoteric surfactant, glycerin and optionally the magnesium sulfate make up a large amount, or even substantially all of the total weight of the solid tablet compositions. For example, in some embodiments few or no additional functional ingredients are disposed therein.

In other embodiments, additional functional ingredients may be included in the solid tablet compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used.

In some embodiments, the solid tablet compositions may include acetate salts, C₆ saccharide derivative sequestrants, optical brighteners, defoaming agents, anti-redeposition agents, bleaching agents, solubility modifiers, dispersants, metal protecting agents, soil antiredeposition agents, stabilizing agents, corrosion inhibitors, builders/sequestrants/chelating agents, enzymes, aesthetic enhancing agents including fragrances and/or dyes, additional rheology and/or solubility modifiers or thickeners, hydrotropes or couplers, buffers, solvents, tablet binders, tablet lubricants, additional cleaning agents and the like.

According to embodiments of the disclosure, the various additional functional ingredients may be provided in a solid tablet composition in the amount from about 0 wt-% and about 25 wt-%, from about 0 wt-% and about 20 wt-%, from about 0.01 wt-% and about 20 wt-%, from about 0.1 wt-% and about 10 wt-%, or from about 1 wt-% and about 10 wt-%. In addition, without being limited according to the disclosure, all ranges recited are inclusive of the numbers defining the range and include each integer within the defined range.

### Acetate Salts

The tablet compositions can further comprise acetate salts.

In some applications, a water soluble acetate salt is preferred. The acetate salt can be a water soluble acetate salt in anhydrous form. In some applications, the acetate is an anhydrous salt of an alkali metal. Preferred among these are the anhydrous sodium acetate salts and potassium acetate salts. In some applications, the acetate is an anhydrous salt of an alkaline earth metal. Preferred among these are the anhydrous calcium acetate salts and magnesium acetate salts. In some applications, the anhydrous acetate salt composition is selected from among sodium acetate, potassium acetate, calcium acetate, magnesium acetate, sodium diacetate, potassium diacetate and combinations thereof. Acetate salts, including anhydrous forms of acetate salts, are commercially available (e.g., from Niacet Corporation, Niagara Falls, N.Y.; Chem One Ltd., Houston, Tex., USA; Vasa Pharmachem Pvt. Ltd., Gujarat, India; and J&K Scientific GmbH, Pforzheim, Germany).

In some embodiments, the acetate salt is included in the tablet composition at an amount of at least about 0 wt-% to about 20 wt-%, about 1 wt-% to about 20 wt-%, about 5 wt-% to about 20 wt-%, or about 10 wt-% to about 15 wt-%. In addition, without being limited according to the disclosure, all ranges recited are inclusive of the numbers defining the range and include each integer within the defined range.

### C6 Saccharide Derivative Sequestrants

The tablet compositions can further comprise C6 saccharide derivative sequestrants.

A C6 saccharide derivative sequestrant refers to an amino derivative or a hydrogenated or an oxidized derivative of a sugar that contains six C atoms (aldohexoses and ketohexoses). Exemplary of the C6 saccharide derivative sequestrants are the amino hexoses, hexitols, aldonic acids and salts thereof, aldonic acid lactones and salts thereof, hexose-6-lactones and salts thereof, and saccharic acids and salts thereof.

As used herein, “amino hexose” refers to a sugar or saccharide having six C atoms that contains an amino group in place of a hydroxyl group. Glucosamine, galactosamine, mannosamine and derivatives of amino containing sugars, such as N-acetylglucosamine, N-acetyl mannosamine and N-acetyl galactosamine are examples of amino hexoses. As used herein, “hexitol” refers to a sugar containing six C atoms in which the aldehyde or ketone group has been reduced (hydrogenated) to an alcohol. Examples of hexitols include allitol, altritol (talitol), fucitol, galactitol (dulcitol), glucitol (sorbitol), iditol, and mannitol. As used herein, an “aldonic acid” refers to any one of a family of sugar acids obtained by oxidation of the aldehyde functional group of an aldose to form a carboxylic acid functional group. As used herein, an “aldonic acid lactone” refers to a lactone of an aldonic acid. The term “lactone” refers a cyclic ester that is the condensation product of a hydroxy group and a carboxylic acid group in the same molecule. As used herein, a “saccharic acid” refers to an oxidized sugar usually produced by oxidizing a sugar with nitric acid, resulting in a compound having the formula C6H10O8. In this oxidized form of sugar, the carbon atom bearing the primary hydroxyl group and the aldehydic carbon atom are oxidized to carboxylic acid groups.

Exemplary sequestrants include for example an oxidized C₆ saccharide that is an aldonic acid lactone. Exemplary aldonic acid lactones include allonolactone, altronolactone, gluconolactone, mannolactone, gulonolactone, idonolactone, galactonolactone, talonolactone. In some applications, the C6 saccharide derivative sequestrant is or contains an aldonic acid lactone selected from among gluconolactone, mannolactone, gulonolactone and galactonolactone and combinations thereof. In some applications, the C6 saccharide derivative sequestrant is or contains a gluconolactone. The C6 saccharide derivative sequestrant can contain one or more aldonic acid lactones in combination with another C6 saccharide derivative sequestrant. Additional examples of exemplary C6 saccharides are set forth in U.S. Pat. No. 11,136,537 which is incorporated herein by reference in its entirety.

In some embodiments, the C6 saccharide derivative sequestrants is included in the tablet composition at an amount of at least about 0 wt-% to about 10 wt-%, about 1 wt-% to about 10 wt-%, about 1 wt-% to about 5 wt-%, or about 2 wt-% to about 5 wt-%. In addition, without being limited according to the disclosure, all ranges recited are inclusive of the numbers defining the range and include each integer within the defined range.

### Methods of Use

The tablet compositions are suited for a variety of uses both consumer and institutional. The tablet compositions are pressed solids that beneficially provide stabilized foaming and fast dissolution times for the tablets thereby enabling their use in various consumer and institutional applications. In addition, the tablet compositions provide high foaming formulations with a significantly smaller amount of surfactant active ingredients in comparison to commercial competitive liquid product formulations. It is a benefit to achieve the high foaming at a lower active surfactant concentration while also delivering the benefits of a solid composition, such as storage, delivery, stability and use benefits that include cost, ease in handling and safety of handling. Moreover, the tablet compositions are particularly suitable for unit dose delivery of a use solution for a particular application as described herein.

The high foaming formulations are beneficially achieved with a use solution generated from the tablet composition having a total active surfactant concentration less than or equal to about 1000 ppm, less than or equal to about 800 ppm, or less than or equal to about 500 ppm. The solid tablet composition that is dissolved for contact with an article or substrate to be cleaned can be referred to as the use solution of the composition. The use solution can beneficially be provided having a total active surfactant concentration less than or equal to about 1000 ppm less than or equal to about 800 ppm, or less than or equal to about 500 ppm.

In embodiments the tablet compositions achieve a fast dissolution, namely a dissolution into a use solution within about 15 minutes or less, about 14 minutes or less, about 13 minutes or less, about 12 minutes or less, about 11 minutes or less, or about 10 minutes or less, about 9 minutes or less, about 8 minutes or less, about 7 minutes or less, about 6 minutes or less, or about 5 minutes or less in an aqueous solution, such as water, at a temperature of at least about 20° C. (68° F.). As one skilled in the art will ascertain the volume of the aqueous solution, such as water, can vary depending upon the size of the tablet composition.

In further embodiments the tablet compositions achieve a fast dissolution, namely a dissolution into a use solution within about 10 minutes or less, in an aqueous solution, such as water, at a temperature of at least about 40° C. (104° F.). This is a significant benefit as 10 minutes appropriates the about of time for an average 10-gallon sink to fill to its desired volume within with a tablet composition as described herein with that period of time. As a result there is minimal to no additional waiting time for the tablet composition to dissolve into a use solution. As one skilled in the art will ascertain the volume of the aqueous solution, such as water, can vary depending upon the size of the tablet composition.

The rapid dissolution of the tablet compositions is achieved with substantially all of the solid is dissolved in the aqueous solution, preferably water. In referring to substantially all of the solid being dissolved this includes about 90% or more of the tablet composition.

The use solutions of the tablet composition are obtained by dissolving the tablet composition into an aqueous solution, preferably water. The use solution has a pH between about 2 and about 11. In an embodiment, the use solution has a pH between about 5 and about 6.

In an embodiment, the tablet compositions are useful as detergent compositions, both consumer (i.e. home use) and institutional. In a preferred embodiment the tablet compositions are particularly well suited for manual sink detergent compositions, including for washing wares including pots and pans, soaking applications, and the like. In such applications, the tablet composition is added to a sink with water to dissolve and provide high foaming for manual sink detergency. Manual sink detergency applications benefit from the high foaming of the tablet compositions as they are used in a manual sink without the automatic agitation and cleaning forces of an automatic warewash machine. The use of the tablet compositions can beneficially provide cleaning efficacy.

In embodiments use solutions of the detergent compositions include from about 30 ppm to about 100 ppm of the surfactants.

In another embodiment, the tablet compositions are useful as foaming hand soap compositions. This use is suitable for both consumer and institutional use of the foaming hand soap compositions. In such applications, the tablet composition is added to a vessel with water to dissolve and provide high foaming for a hand soap application. Hand soaks benefit from the high foaming of the tablet compositions as they are used to manually clean hands where foaming is desired by a user.

In embodiments use solutions of the foaming hand soap compositions include from about 2,000 ppm to about 5,000 ppm of the surfactants.

In another embodiment, the tablet compositions are useful as hard surface cleaning and/or sanitizing compositions. This use is suitable for both consumer and institutional use of the hard surface cleaning compositions. The hard surface cleaning and/or sanitizing can generate a use solution of the tablet composition in a bucket or other vessel for manual hard surface cleaning and/or sanitizing, such as saturating a wipe, cloth, mop, sponge or the like with the use solution of the tablet composition to contact various hard surfaces for cleaning and/or sanitizing. In other embodiments, the tablet composition can be added into a spray bottle or other vessel where a use solution of the tablet composition is generated and thereafter the use solution is sprayed onto a hard surface for cleaning and/or sanitizing.

For hard surface cleaning applications, it may be desirable to reduce the foaming generated with the use solution of the tablet composition. In such embodiments where reduced foaming is desired the wt-% of the anionic surfactant and/or the wt-% of the glycerin can be reduced to decrease foaming in the use solution of the tablet composition.

In embodiments use solutions of the hard surface cleaning and/or sanitizing compositions include from about 300 ppm to about 500 ppm of the surfactants.

In yet another embodiment, the tablet compositions are useful as carpet shampoo compositions. This use is suitable for both consumer and institutional use of the carpet shampoo compositions. For carpet shampooing or carpet cleaning applications it may be desirable to reduce the foaming generated with the use solution of the tablet composition. In such embodiments where reduced foaming is desired the wt-% of the anionic surfactant and/or the wt-% of the glycerin can be reduced to decrease foaming in the use solution of the tablet composition.

In embodiments use solutions of the carpet shampoo compositions include from about 30 ppm to about 500 ppm of the surfactants.

### EMBODIMENTS

The present disclosure is further defined by the following numbered embodiments:

1. A solid tablet composition comprising: an alkali metal carbonate alkalinity source; an acid component; an anionic surfactant; an amphoteric surfactant; and glycerin, wherein the weight-% ratio of the components in the solid tablet composition is from about 2:1:2 (anionic surfactant to amphoteric surfactant to glycerin) to about 3:1:3, or from about 2:1:2 to about 3:1:2.

2. The composition of paragraph 1, wherein the acid component comprises a polycarboxylic acids, preferably a polycarboxylic acid having between 2 and 4 carboxyl groups.

3. The composition of any one of paragraphs 1-2, wherein the anionic surfactant comprises linear alkylbenzene sulfonate, sodium dodecylbenzene sulfonate, sodium lauryl sulfate, sodium coco-sulfate, sodium alpha-olefin sulfonate, sodium laureth sulfate, sodium lauroyl sulfoacetate, sodium methyl cocoyl taurate, sodium lauryl sarcosinate, sodium cocoyl isethionte, lauryl glucosides, coco glucosides, or combinations thereof.

4. The composition of any one of paragraphs 1-3, wherein the amphoteric surfactant comprises a cocamidopropyl betaine, cocamidopropyl hydroxysultaine, lauramidopropyl betaine, amidopropyl betaine, amidopropyl hydroxysultaine, sodium cocamphoacetate, sodium cocamphopropionate, cocamidopropylamine oxide, lauryldimethylamine oxide, or combinations thereof.

5. The composition of any one of paragraphs 1-4, comprising from about 0.1 wt-% to about 10 wt-% of the anionic surfactant, from about 0.05 wt-% to about 10 wt-% of the amphoteric surfactant, and from about 0.1 wt-% to about 10 wt-% of the glycerin.

6. The composition of any one of paragraphs 1-5, further comprising magnesium sulfate.

7. The composition of paragraph 6, wherein the weight-% ratio of the components in the solid tablet composition is from about 2:1:2:0.5 (anionic surfactant to amphoteric surfactant to glycerin to magnesium sulfate) to about 3:1:3:1, or from about 2:1:2:0.5 to about 3:1:2:1.

8. The composition of any one of paragraphs 6-7, comprising from about 0.1 wt-% to about 10 wt-% of the anionic surfactant, from about 0.05 wt-% to about 10 wt-% of the amphoteric surfactant, from about 0.1 wt-% to about 10 wt-% of the glycerin, and from about 0.1 wt-% to about 10 wt-% of the magnesium sulfate, or from about 1 wt-% to about 10 wt-% of the anionic surfactant, from about 0.1 wt-% to about 10 wt-% of the amphoteric surfactant, from about 1 wt-% to about 10 wt-% of the glycerin, and from about 0.1 wt-% to about 5 wt-% of the magnesium sulfate.

9. The composition of any one of paragraphs 1-8, wherein the alkali metal carbonate alkalinity source comprises from about 10 wt-% to about 40 wt-% of the composition, and wherein the acid component comprises from about 20 wt-% to about 60 wt-% of the composition.

10. The composition of any one of paragraphs 1-9, wherein the tablet is a unit dose.

11. The composition of any one of paragraphs 1-10, wherein the tablet is a detergent cleaning composition, a foaming hand soap composition, a hard surface cleaning composition, or a carpet shampoo composition.

12. The composition of paragraph 11, wherein the tablet is a hard surface cleaning composition or a carpet shampoo composition, and wherein the wt-% of the anionic surfactant and/or glycerin is reduced to decrease foaming in the composition.

13. The composition of any one of paragraphs 1-12, wherein the tablet composition has a tablet hardness between about 10-40 lb-f.

14. The composition of any one of paragraphs 1-13, further comprising one or more additional functional ingredients.

15. The composition of paragraph 13, wherein the additional functional ingredient comprises an acetate salt in an amount from about 1 wt-% to about 20 wt-% of the composition and/or a C₆ saccharide in an amount from about 1 wt-% to about 10 wt-% of the composition.

16. A use solution of a tablet composition comprising: an aqueous solution of the tablet composition according to any one of paragraphs 1-15, wherein the aqueous solution has a pH between about 2 and about 11, and stabilized foam with a total active surfactant concentration less than or equal to about 1000 ppm.

17. A method of use comprising: adding a tablet composition according to any one of paragraphs 1-15 into an aqueous solution to dissolve the tablet composition to form a use solution within about 15 minutes or less and contacting a surface with the use solution; or contacting the use solution according to paragraph 16 with a surface.

18. The method of paragraph 17, wherein the step of dissolving the tablet composition to form the use solution is achieved within about 10 minutes or less is in an aqueous solution at a temperature of at least about 40° C. (104° F.), or wherein the step of dissolving the tablet composition to form the use solution is achieved within about 15 minutes or less is in an aqueous solution of cold water of about 20° C. (68° F.) or less.

19. The method of paragraphs 17 or 18, wherein the tablet composition is about 5 grams to about 30 g and added into the aqueous solution at a size and dissolution between about 0.5-20 grams tablet composition per Liter of the aqueous solution for dissolution.

20. The method of any one of paragraphs 17-19, wherein the aqueous solution is water.

21. The method of any one of paragraphs 17-20, wherein the use solution has a pH between about 2 and about 11.

22. The method of any one of paragraphs 17-21, wherein the methods of use do not require use of personal protective equipment and the use solution has a pH from about 4-9.

23. The method of any one of paragraphs 17-22, wherein the method of use is for consumer and/or institutional applications of use, and preferably wherein the method of use is for detergent cleaning, ware washing in a sink, pot and pan cleaning, a foaming hand soap, hard surface cleaning, or a carpet shampoo.

24. The method of any one of paragraphs 17-23, wherein the use solution is formed in a sink, bucket, bottle or other vessel.

25. The method of paragraph 24, wherein the use solution is further saturated onto a wipe, cloth, mop or other apparatus to apply to a hard surface.

26. The method of paragraph 24, wherein the use solution is further sprayed onto a hard surface and thereafter wiped with a wipe, cloth, mop or other apparatus to contact the hard surface.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following ingredients are utilized in the Examples:
Anionic Surfactant: Alpha Olefin Sulfonate (AOS)
Anionic Surfactant: Sodium Lauryl Sulfate (SLS)
Anionic Surfactant: Linear Alkyl Benzene Sulfonate (LAS)
Anionic Surfactant: Sodium Dodecylbenzene Sulfonate (SDS)
Anionic Surfactant: Sodium Cocoyl Glutamate
Anionic Surfactant: Sodium Xylene Sulfonate (SXS)
Anionic Surfactant: Sodium Lauryl Ether Sulfate (SLES)
Anionic Surfactant: Lauryl Glucoside
Anionic Surfactant: Sodium Lauryl Glucose Carboxylate
Amphoteric Surfactant: Lauryl Dimethylamine Oxide
Amphoteric Surfactant: Cocamidopropyl Betaine
Nonionic Surfactant: C9-C11 Linear Alcohol Ethoxylate
Nonionic Surfactant: Lauryl Alcohol Ethoxylate
Glycerin
Magnesium Sulfate

### Example 1

In this Example, foam height and soil removal efficacies were tested for the formulations A through G in Table 2.

TABLE 2

| | | Amphoteric | Other | | Mg |
|---|---|---|---|---|---|
| | Anionic Surfactant | Surfactant | Surfactants | Glycerin | Sulfate |
| A | 9% AOS and 4.6% | 4.7% Lauryl | | None | None |
| | SLES and 2.4% SXS | Dimethylamine | | | |
| | | Oxide | | | |
| B | 1.1% Sodium Lauryl | None | None | 2.2% | None |
| | Glucose Carboxylate | | | | |
| | and Lauryl Glucoside | | | | |
| C | 10% AOS and | None | None | None | None |
| | 10% SLES | | | | |
| D | 10% LAS | None | None | None | None |
| E | 5% SDS and | None | None | 2.2% | 1% |
| | 1.1% Sodium Cocoyl | | | | |
| | Glutamate | | | | |
| F | None | None | 10% C9-C11 | None | None |
| | | | Linear Alcohol | | |
| | | | Ethoxylate | | |
| G | 2.6% SDS | 1.07% | None | 2.7% | 0.8% |
| | | Cocamidopropyl | | | |
| | | Betaine | | | |

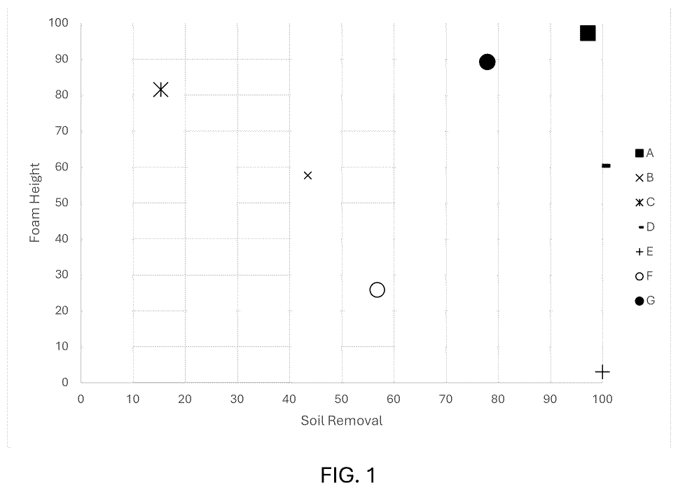

The foam height was tested with the following procedure. 40 ml of a use solution (e.g. 9 g tablet dissolved in a liter of water) was placed in a 250 ml graduated cylinder and stoppered. Each cylinder was placed in a foam height testing unit that inverts stoppered cylinders and rotates at 30 rpm. The samples were run for four minutes. The foam height was recorded, subtracting 40 ml for the initial solution. Two drops of spent fryer shortening was added to each cylinder. The cylinders were then placed in the testing unit for two minutes and the foam height was recorded, again subtracting 40 ml for the initial use solution. The cycle of adding two drops of shortening, running the sample two minutes in the testing unit, and recording the foam height was repeated for a total of 8 cycles (including the first four minute cycle), or until the foam height reached 0. Four samples were taken for each formulation in Table 2. Overall foam height is calculated by taking the sum of all four samples and dividing by 6720. This foam height is recorded in Table 3 and plotted versus soil removal in FIG. 1.

Soil removal was test with the following procedure. Spent shortening was applied to vinyl tiles and allowed to cure. An initial weight was then taken for each tile. Each tile was soaked for 10 minutes in a 9 g/L use solution. The tiles were removed from the cleaning solution, lightly rinsed, and allowed to dry. The tiles were then evaluated for weight loss.

TABLE 3

| Sample | Soil Removal | Foam Height |
|---|---|---|
| A | 52.4 | 97.2 |
| B | 43.5 | 57.6 |
| C | 15.3 | 81.5 |
| D | 100 | 60.3 |
| E | 100 | 3 |
| F | 56.8 | 25.8 |
| G | 77.9 | 89.2 |

The overall foam height and overall soil removal is recorded in Table 3. Foam height versus soil removal is plotted in FIG. 1. As can be seen from FIG. 1, Formulation G maintains excellent foam height with great soil removal.

### Example 2

A 9 gram tablet of the according to the formula shown in Table 4 for the solid tablet composition was added directly into a spray bottle to generate use solutions to deliver the following ppm surfactants at the dilution ranges shown in Table 5.

TABLE 4

| Formula | (wt-%) |
|---|---|
| Dye | 0-0.5% |
| Light Ash | 20-35% |
| Sodium Acetate | 4-6% |
| Sod Alkyl Benz Sulfonate | 2-4% |
| PEG 8000 | 3-5% |
| Magnesium Sulfate | 0-2% |
| Heptahydrate | |
| Glycerol Triacetate | 5-8% |
| Glucono-delta-Lactone | 4-6% |
| Cocamidopropyl Betaine | 2-4% |
| Citric Acid | 40-55% |
| Total | 100% |

TABLE 5

| Solid Composition | | |
|---|---|---|
| Surfactant ppm | Volume Solution | |
| 360 ppm | 1 | L |
| 720 ppm | 0.5 | L |
| 514 ppm | 700 | mL |

The solutions were then suitable to directly spray onto a surface, such as a dirty dish, to be scrubbed clean. The concentrations shown in Table 5 are the concentration of surfactants only and excludes the other materials in the composition of Table 4. This application of use provides unique benefit of obviating the needs for filling a sink full of detergent water for cleaning. The solution is also then portable to use for various applications in distinct locations for a user.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A solid tablet composition comprising:
an alkali metal carbonate alkalinity source;
an acid component;
an anionic surfactant;
an amphoteric surfactant; and
glycerin,
wherein the weight-% ratio of the components in the solid tablet composition is from about 2:1:2 (anionic surfactant to amphoteric surfactant to glycerin) to about 3:1:3.

2. The composition of claim 1, wherein the acid component comprises a polycarboxylic acids, preferably a polycarboxylic acid having between 2 and 4 carboxyl groups.

3. The composition of claim 1, wherein the anionic surfactant comprises linear alkylbenzene sulfonate, sodium dodecylbenzene sulfonate, sodium lauryl sulfate, sodium coco-sulfate, sodium alpha-olefin sulfonate, sodium laureth sulfate, sodium lauroyl sulfoacetate, sodium methyl cocoyl taurate, sodium lauryl sarcosinate, sodium cocoyl isethionte, lauryl glucosides, coco glucosides, or combinations thereof.

4. The composition of claim 1, wherein the amphoteric surfactant comprises a cocamidopropyl betaine, cocamidopropyl hydroxysultaine, lauramidopropyl betaine, amidopropyl betaine, amidopropyl hydroxysultaine, sodium cocamphoacetate, sodium cocamphopropionate, cocamidopropylamine oxide, lauryldimethylamine oxide, or combinations thereof.

5. The composition of claim 1, comprising from about 0.1 wt-% to about 10 wt-% of the anionic surfactant, from about 0.05 wt-% to about 10 wt-% of the amphoteric surfactant, and from about 0.1 wt-% to about 10 wt-% of the glycerin.

6. The composition of claim 1, further comprising magnesium sulfate.

7. The composition of claim 6, wherein the weight-% ratio of the components in the solid tablet composition is from about 2:1:2:0.5 (anionic surfactant to amphoteric surfactant to glycerin to magnesium sulfate) to about 3:1:3:1.

8. The composition of claim 6, comprising either (i) from about 0.1 wt-% to about 10 wt-% of the anionic surfactant, from about 0.05 wt-% to about 10 wt-% of the amphoteric surfactant, from about 0.1 wt-% to about 10 wt-% of the glycerin, and from about 0.1 wt-% to about 10 wt-% of the magnesium sulfate, or (ii) from about 1 wt-% to about 10 wt-% of the anionic surfactant, from about 0.1 wt-% to about 10 wt-% of the amphoteric surfactant, from about 1 wt-% to about 10 wt-% of the glycerin, and from about 0.1 wt-% to about 5 wt-% of the magnesium sulfate.

9. The composition of claim 1, wherein the alkali metal carbonate alkalinity source comprises from about 10 wt-% to about 40 wt-% of the composition, and wherein the acid component comprises from about 20 wt-% to about 60 wt-% of the composition.

10. The composition of claim 1, wherein the tablet is a unit dose.

11. The composition of claim 1, wherein the tablet is a detergent cleaning composition, a foaming hand soap composition, a hard surface cleaning composition, or a carpet shampoo composition, or wherein the tablet is a hard surface cleaning composition or a carpet shampoo composition, and wherein the wt-% of the anionic surfactant and/or glycerin is reduced to decrease foaming in the composition.

12. The composition claim 1, wherein the tablet composition has a tablet hardness between about 10-40 lb-f.

13. The composition of claim 1, further comprising one or more additional functional ingredients, and optionally wherein the additional functional ingredient comprises an acetate salt in an amount from about 1 wt-% to about 20 wt-% of the composition and/or a C6 saccharide in an amount from about 1 wt-% to about 10 wt-% of the composition.

14. A use solution of a tablet composition comprising:
an aqueous solution of the tablet composition according to claim 1,
wherein the aqueous solution has a pH between about 2 and about 11, and stabilized foam with a total active surfactant concentration less than or equal to about 1000 ppm.

15. A method of use comprising:
adding a tablet composition according to claim 1 into an aqueous solution to dissolve the tablet composition to form a use solution within about 15 minutes or less and contacting a surface with the use solution; or
contacting the use solution with a surface, wherein the use solution is an aqueous solution of the tablet composition according to claim 1, wherein the aqueous solution has a pH between about 2 and about 11, and stabilized foam with a total active surfactant concentration less than or equal to about 1000 ppm.

16. The method of claim 15, wherein the step of dissolving the tablet composition to form the use solution is achieved within about 10 minutes or less is in an aqueous solution at a temperature of at least about 40° C. (104° F.), or wherein the step of dissolving the tablet composition to form the use solution is achieved within about 15 minutes or less is in an aqueous solution of cold water of about 20° C. (68° F.) or less.

17. The method of claim 15, wherein (i) the tablet composition is about 5 grams to about 30 g and added into the aqueous solution at a size and dissolution between about 0.5-20 grams tablet composition per Liter of the aqueous solution for dissolution, (ii) the aqueous solution is water and wherein the use solution has a pH between about 2 and about 11, and/or (iii) the methods of use do not require use of personal protective equipment and the use solution has a pH from about 4-9.

18. The method of claim 15, wherein the method of use is for consumer and/or institutional applications of use, and preferably wherein the method of use is for detergent cleaning, ware washing in a sink, pot and pan cleaning, a foaming hand soap, hard surface cleaning, or a carpet shampoo.

19. The method of claim 15, wherein the use solution is formed in a sink, bucket, bottle or other vessel.

20. The method of claim 19, wherein the use solution is further saturated onto a wipe, cloth, mop or other apparatus to apply to a hard surface, or wherein the use solution is further sprayed onto a hard surface and thereafter wiped with a wipe, cloth, mop or other apparatus to contact the hard surface.
